(19) United States
(12) Patent Application Publication
(10) Pub. No.: US 2019/0202274 A1
(43) Pub. Date: Jul. 4, 2019

(54) Vehicle Cover Assembly with Repositionable Magnets

(71) Applicant: Bernard Bates, Oshawa (CA)

(72) Inventor: Bernard Bates, Oshawa (CA)

(21) Appl. No.: 15/856,565

(22) Filed: Dec. 28, 2017

(51) Int. Cl. B60J 11/04

(52) U.S. Cl. CPC B60J 11/04; B60Y 2410/132

(57) ABSTRACT

A vehicle cover assembly with repositionable magnets for magnetically securing a vehicle cover to a vehicle includes an inner liner that is positioned on a vehicle. A cover is attached to the inner liner. The cover comprises a liquid impermeable material wherein the liquid impermeable material protects the vehicle from moisture. A plurality of pockets is positioned on the cover. Each of the pockets has an upper edge. Each of the upper edges exposes an interior of the corresponding pocket to define an opening into said corresponding pocket. A plurality of magnets is included. The opening in each of the pockets selectively receives one of the magnets. Each of the magnets magnetically engages to the vehicle to secure the cover to the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to magnetic vehicle cover devices and more particularly pertains to a new magnetic vehicle cover device for magnetically securing a vehicle cover to a vehicle.

### BRIEF SUMMARY OF THE INVENTION

An embodiment of the disclosure meets the needs presented above by generally comprising an inner liner that is configured to be positioned on a vehicle. A cover is attached to the inner liner. The cover comprises a liquid impermeable material wherein the liquid impermeable material is configured to protect the vehicle from moisture. A plurality of pockets is positioned on the cover. Each of the pockets has an upper edge. Each of the upper edges exposes an interior of the corresponding pocket defining an opening into said corresponding pocket. A plurality of magnets is included. The opening in each of the pockets selectively receives one of the magnets. Each of the magnets is configured to be magnetically engaged to the vehicle to secure the cover to the vehicle.

The magnets are moveable within the pockets to allow a person to selectively move the magnets where needed relative to the vehicle and the cover.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S

The disclosure will be better understood and objects other than those set forth above will become apparent when consideration is given to the following detailed description thereof. Such description makes reference to the annexed drawings wherein:

FIG. 1 is a front side view of a vehicle cover assembly with repositionable magnets according to an embodiment of the disclosure.

FIG. 2 is a bottom view of an embodiment of the disclosure.

FIG. 3 is a cross-sectional view of an embodiment of the disclosure taken along line 3-3 of FIG. 1.

FIG. 4 is a side view of an embodiment of the disclosure.

FIG. 5 is a front view of an embodiment of the disclosure.

### DETAILED DESCRIPTION OF THE INVENTION

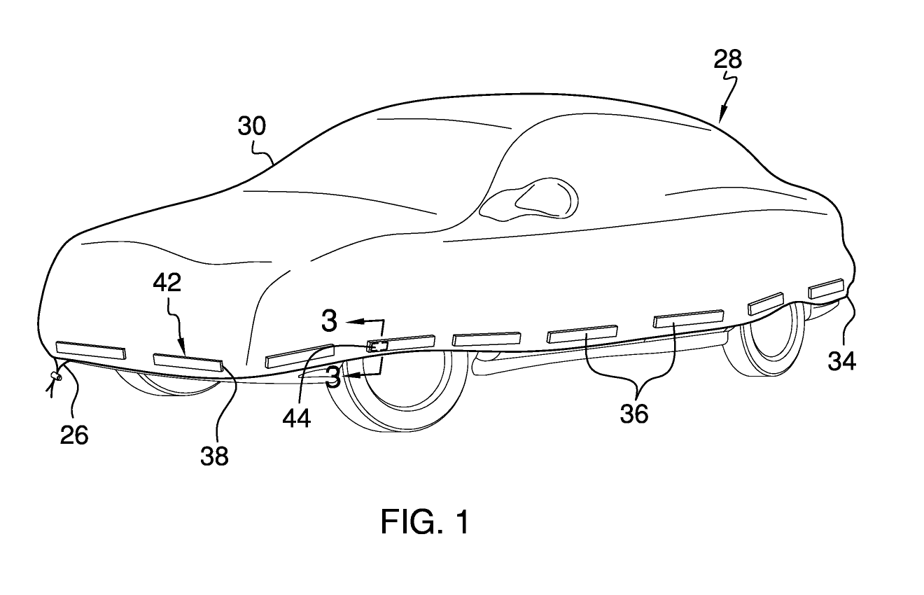

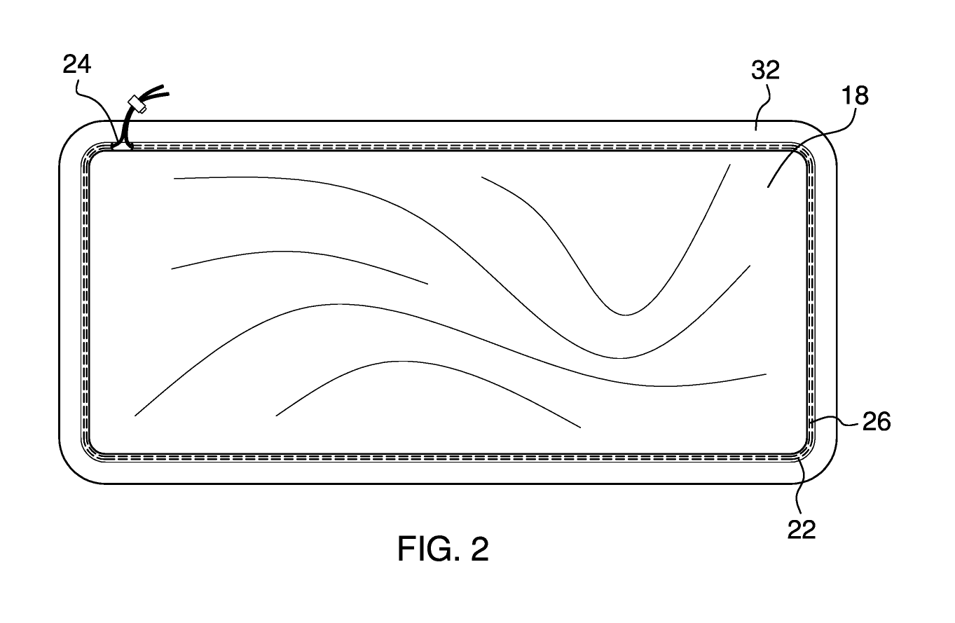

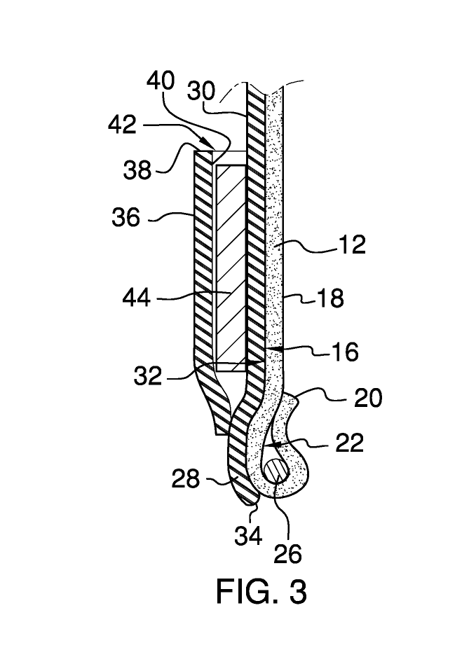

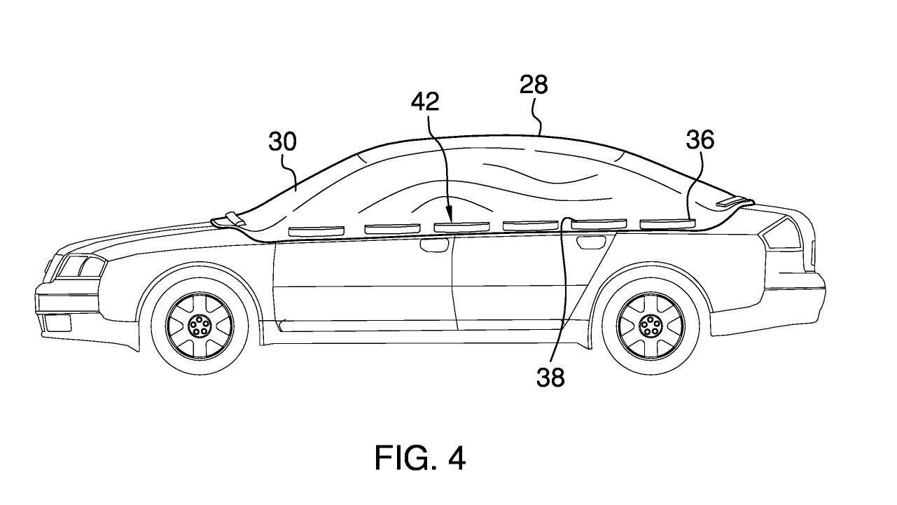

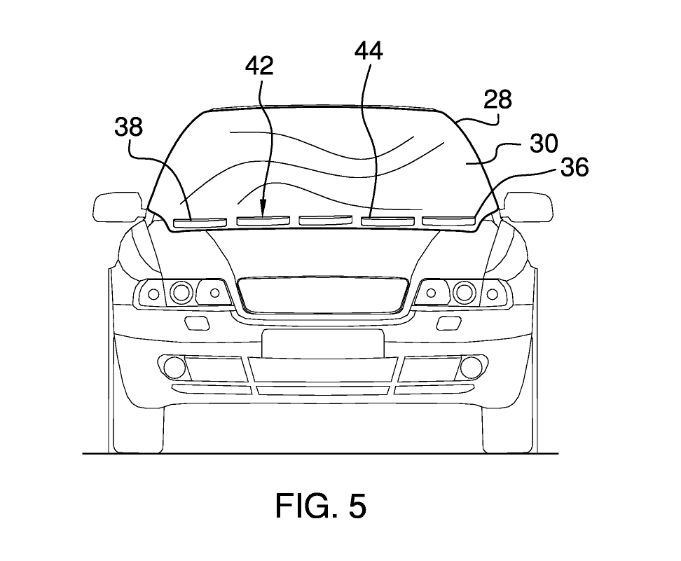

With reference now to the drawings, and in particular to FIGS. 1 through 5 thereof, a new magnetic vehicle cover device embodying the principles and concepts of an embodiment of the disclosure and generally designated by the reference numeral 10 will be described.

As best illustrated in FIGS. 1 through 5, the vehicle cover assembly with repositionable magnets 10 generally comprises an inner liner 12 that is positioned on a vehicle 14. The inner liner 12 has a top surface 16, a bottom surface 18 and a peripheral edge 20. The bottom surface 18 rests on the vehicle 16. The inner liner 12 folds toward the bottom surface 18 such that the peripheral edge 20 is attached to the bottom surface 18 and defines a channel 22. The channel 22 has an aperture 24 that extends therein.

A drawstring 26 is positioned in the channel 22. The drawstring 26 extends outwardly from the aperture 24 such that the drawstring 26 is tightenable. The drawstring 26 tightens the inner liner 12 around the vehicle 14 to secure the inner liner 12 to the vehicle 14.

A cover 28 is attached to the inner liner 12. The cover 28 comprises a liquid impermeable material wherein the liquid impermeable material protects the vehicle 14 from moisture. The cover 28 has an outer surface 30, an inner surface 32 and a perimeter edge 34. The inner surface 32 is attached to the top surface 16.

A plurality of pockets 36 is positioned on the cover 28. Each of the pockets 36 has an upper edge 38. The upper edge 38 exposes an interior 40 of the pocket to define an opening 42 into the pocket 36. Each of the pockets 36 is spaced from the perimeter edge 34. Additionally, each of the pockets 36 are spaced from each other and distributed around the perimeter edge 34.

A plurality of magnets 44 is included. The opening 42 in each of the pockets 36 selectively receives one of the magnets 44. Each of the magnets 44 magnetically engages to the vehicle 14 to secure the cover 28 to the vehicle 14. The pockets 36 each have a length and width that is at least four times a length and width of the magnets 44 such that each of the magnets 44 is movable within the corresponding one of the pockets 36. Each of the magnets 44 may be positioned in selected ones of the pockets 36 to most securely magnetize the cover 28 to the vehicle 14. Furthermore, a magnet 44 is not required to be positioned in every pocket 36.

In use, the cover 28 is positioned over the vehicle 14 such that the bottom surface 18 rest on the vehicle 14. The drawstring 26 is tightened to tighten the inner liner 12 on the vehicle 14. The magnets 44 are selectively positioned into pockets 36 to most securely magnetize the cover 28 to the vehicle's body 14 wherein the cover 28 keeps moisture off the vehicle 14 and is not easily removed by weather.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cover assembly having a plurality of repositionable magnets therein configured to secured said cover to a vehicle, said assembly comprising:
an inner liner being configured to be positioned on a vehicle;
a cover being attached to said inner liner, said cover comprising a liquid impermeable material wherein said liquid impermeable material is configured to protect the vehicle from moisture;
a plurality of pockets being positioned on said cover, each of said pockets having an upper edge, said upper edge exposing an interior of said pockets defining an opening into said pockets; and
a plurality of magnets, said opening in each of said pockets selectively receiving one of said magnets, each of said magnets being configured to be magnetically engaged to the vehicle to secure said cover to the vehicle, said pockets having a length and width each being at least four times a length and width of said magnets, said magnets being movable within said pockets.

2. A cover assembly according to claim 1, wherein said inner liner has a top surface, a bottom surface and a peripheral edge, said bottom surface being configured to rest on the vehicle.

3. A cover assembly according to claim 2, wherein said inner liner folds toward said bottom surface such that said peripheral edge is attached to said bottom surface to define a channel, said channel having an aperture extending therein.

4. A cover assembly according to claim 3, wherein further including a drawstring being positioned in said channel, said drawstring extending outwardly from said aperture, said drawstring being configured to tighten said inner liner around the vehicle thereby securing said inner liner to the vehicle.

5. A cover assembly according to claim 2, wherein said cover has an outer surface, an inner surface and a perimeter edge, said inner surface being attached to said top surface.

6. A cover assembly according to claim 5, wherein each of said pockets is spaced from said perimeter edge, said pockets being spaced from each other and being distributed around said perimeter edge.

7. A cover assembly having a plurality of repositionable magnets therein configured to secured said cover to a vehicle, said assembly comprising:
an inner liner being configured to be positioned on a vehicle, said inner liner having a top surface, a bottom surface and a peripheral edge, said bottom surface being configured to rest on the vehicle, said inner liner folding toward said bottom surface such that said peripheral edge is attached to said bottom surface to define a channel, said channel having an aperture extending therein;
a drawstring being positioned in said channel, said drawstring extending outwardly from said aperture, said drawstring being configured to tighten said inner liner around the vehicle thereby securing said inner liner to the vehicle;
a cover being attached to said inner liner, said cover comprising a liquid impermeable material wherein said liquid impermeable material is configured to protect the vehicle from moisture, said cover having an outer surface, an inner surface and a perimeter edge, said inner surface being attached to said top surface;
a plurality of pockets being positioned on said cover, each of said pockets having an upper edge, said upper edge exposing an interior of said pockets defining an opening into said pockets, each of said pockets being spaced from said perimeter edge, said pockets being spaced from each other and being distributed around said perimeter edge; and
a plurality of magnets, said opening in each of said pockets selectively receiving one of said magnets, each of said magnets being configured to be magnetically engaged to the vehicle to secure said cover to the vehicle, said pockets having a length and width each being at least four times a length and width of said magnets, said magnets being movable within said pockets.
